(19) United States
(12) Patent Application Publication
(10) Pub. No.: US 2002/0198782 A1
(43) Pub. Date: Dec. 26, 2002

(54) System and method for reducing customer turnover

(76) Inventor: Gary T. Shorter, Oak Brook, IL (US)

Correspondence Address: Le, Mann, Smith, McWilliams, Sweeney & Ohlson, 209 South LaSalle Street, Suite 410, Chicago, IL, 60604, US

(21) Appl. No.: 10/175,195

(22) Filed: Jun. 19, 2002

Related U.S. Application Data
(60) Provisional application No. 60/299,794, filed on Jun. 22, 2001.

(51) Int. Cl. G06F 17/60

(52) U.S. Cl. 705/14

(57) ABSTRACT

A system focused on long-term customer retention by applying an incentive on a monthly, on-going basis as a reward for loyalty. In one form, the invention comprises a method for reducing turnover among subscribers to a service offered by a service provider. The method includes the steps of enrolling a user as a member of a customer network maintained by a subscription system operator, establishing a subscriber account with the service provider on behalf of a member of the customer network, the account having a predetermined basic monthly service cost, implementing a data base of service provider subscribers that indicates an association between each member and the member's referral subscribers, calculating a service credit for the member based upon activity of the referral subscribers, and applying the service credit to offset the member's predetermined basic monthly service cost. Consequently, the member benefits by remaining a subscriber with the service provider in order to continue receiving reduced-cost service. A system for reducing customer turnover is also described.

### CLAIM FOR PRIORITY

The Applicant claims priority based upon U.S. Provisional Application Serial No. 60/299,794 filed Jun. 22, 2001.

### FIELD OF THE INVENTION

This invention relates generally to reducing customer turnover and in particular to a system that encourages subscribers to remain affiliated with their original service provider, and is more particularly directed toward a methodology that reduces customer turnover by providing incentives that lead to lower service costs for participating customers.

### BACKGROUND OF THE INVENTION

There are many enterprises in which service providers spend significant capital to attract new customers, only to have these customers lured away by other service providers. This type of customer turnover is often labeled “churn,” and is considered to be a serious problem by most service providers who depend upon a stable subscriber base.

The steady loss of subscribers represented by churn, although it may only amount to a few percent of the active subscriber base, means that service providers must allocate additional funds in order to attract new subscribers to replace the ones that are lost. The funds originally expended to attract the customer are considered a loss, and the service provider must dream up (and pay for) new promotions in order to attract replacement customers. All of the competing service providers in a particular market end up incurring new costs that are ultimately passed along to subscribers, eroding profits for the service providers and inflating cost-of-service for the subscriber base.

A number of promotional efforts have been made to reduce customer turnover in the wireless telecommunications marketplace. Perhaps the most common is furnishing a customer with a free cellular telephone. Discounted service packages have also been offered, featuring free minutes at the start of the customer service plan. These basic promotional ideas have been ineffective largely because all service providers competing for the same customer base tend to use the same promotions. Once an initial period of customer satisfaction begins to wane, the customer can be lured away by a competitor offering another free telephone with more features, or a larger block of free talk time. Of course, requiring a customer to sign up for a minimum initial time period (such as one year, for example), reduces initial turnover, but this practice merely postpones the churn problem until after the minimum initial period expires.

Another promotion that has been tried is encouraging customers to recruit friends or family members, then rewarding the successful customer by providing a limited amount of free communication with the friends and family members that the customer has attracted. Most subscribers find that talking with the new customers they have managed to recruit accounts for only a small percentage of their actual minutes every month, so the value of this type of promotion is questionable in retaining existing customers.

Incentives have been tried in various contexts as a method of rewarding or attracting customers. For instance, the Kanter patent (U.S. Pat. No. 5,537,314) describes a computer-based system for administering incentive award systems that contemplates multiple sponsoring organizations, multiple levels of participants, and multiple types of incentive realizations. A principal realization of the Kanter system seems to involve a credit card holder who is able to enjoy a plurality of credits or rewards provided by a multitude of sponsoring companies.

The Warsh patent (U.S. Pat. No. 6,226,621) describes an award program adapted for the rental market. In particular, the Warsh scheme provides for an award for a rental property tenant who actively seeks out additional renters for a property with a low occupancy rate. Warsh acknowledges that the award may be paid out in cash, or the tenant's account may be credited. There are also modifications proposed in which the amount of the award decreases with increasing occupancy rate, or payment is deferred until the new tenant occupies the rental space for a minimum time period.

Masi et al. (U.S. Pat. No. 6,105,001) describe an incentive and commission distribution system designed for credit/debit card users. Users of a particular credit/debit card are encouraged to recruit other users and offered a commission based upon total purchases made with the credit/debit card by the users they have recruited. A user hierarchy determines the commission amounts generated by each user that is “downline” from (recruited by) a particular user. Preferably, the incentive system is directed toward particular merchants who agree to provide an organization discount on each transaction using the organization's credit/debit card. In return for this discount, the merchants are allowed access to the organization's database for targeted marketing purposes.

None of these known incentive schemes provide any suggestions for curtailing turnover problems that plague certain classes of service providers. Consequently, a need arises for an effective system that is easy to administer, encourages continuing subscriber participation, and reduces the cost of customer acquisition for the service provider.

### SUMMARY OF THE INVENTION

These needs and others are satisfied by the customer retention methodology of the present invention, which recognizes the ineffectual nature of traditional incentive systems based upon immediate gratification. Traditional methods rely on an inexpensive gift or reward aimed at customer acquisition with little or no thought to the issue of retention. Instead, the present system is focused on long-term customer retention by applying incentives (or partner-funded rebates) on a monthly, on-going basis as a reward for loyalty. The reward is uniquely based upon a pay-for-performance metric, producing a hybrid business model that combines both loyalty and leveraged new customer acquisitions.

The inventive system has particular utility when used to enhance acquisition and retention of subscribers for a service provider, such as a wireless telecommunications service provider. However, the methodology of the present invention should not be considered as limited in effectiveness or utility when applied to products or services other than the telecommunications industry. Other possible fields within which the invention may be applied include, but are by no means limited to, general merchandise sales and distribution, fast food service, gasoline and fuels, Web/ISP (internet service provider), and travel and leisure services. The value proposition is the low cost use of partner-funded incentives (over time) in a hybrid loyalty model that delivers both customer retention (loyalty), and uses leverages for multiple new acquisitions.

In application, a user enrolls as a member of a customer network through a web site on the Internet that is provided by a subscription system operator. Of course, the basic enrollment process could also be carried on by mail or telephone. The basic membership, termed an associate membership, simply enables the user to purchase products through the web site without payment of any activation fee.

The next membership level, termed a silver associate membership, requires the payment of an annual membership fee, and each silver associate receives a premium of substantial value. The premium may comprise a collection of rebates, discounts, and product rewards, for example. Each of the silver associate members also receives a fixed (or, in the alternative, a variable) percent monthly service credit (or, in the alternative, a fixed dollar amount of service credit) for each referral customer who agrees to subscribe with the service provider featured on the web site—in the preferred embodiment, a telecommunications service provider. The third contemplated membership level (gold associate) describes a class of associates who have recruited at least a minimum number (ten, for example) of referral subscribers, and therefore have achieved zero cost-of-service (or, in other words, a 100% rebate of the basic monthly fee for their selected service plan) for their telecommunications needs.

In accordance with one aspect of the present invention, a method is provided for reducing turnover among subscribers to a service offered by a service provider. The method comprises the steps of enrolling a user as a member of a customer network maintained by a subscription system operator, establishing a subscriber account with the service provider on behalf of a member of the customer network, the account having a predetermined basic monthly service cost, implementing a data base of service provider subscribers that indicates an association between each member and the member's referral subscribers, calculating a service credit for the member based upon activity of the referral subscribers, and applying the service credit to offset the member's predetermined basic monthly service cost. Consequently, the member benefits by remaining a subscriber with the service provider in order to continue receiving reduced-cost service. In one form of the invention, the step of enrolling a user as a member of a customer network further comprises the step of requiring payment of an annual membership fee by the member, and providing a premium to the member in return for the membership fee. The premium may be provided, at least in part, in the form of one or more products delivered to the member. In the alternative, the premium may be in the form of discounts redeemable by the member for predetermined products or services.

In another form of the invention, the step of implementing a data base of service provider subscribers further comprises the step of implementing a data base comprising member records, with each record including at least one field that indicates subscribers referred by the member, and at least one associated field that indicates referral subscriber activity with the service provider. The step of calculating a service credit may further include the steps of accessing the data base of member records, enumerating the referral subscribers associated with each member, determining whether a member qualifies for a service credit based upon referral subscriber activity, and computing service credit amount based upon the referral subscriber activity.

In yet another form of the invention, the step of computing service credit amount further comprises the steps of enumerating total active referral subscribers, multiplying total active referral subscribers by a fixed percentage to determine service credit percentage, and reducing the member's monthly service cost by the service credit percentage. The fixed percentage may, for example, be 8.33%. In the alternative, the step of computing service credit amount may further comprise the steps of enumerating total active referral subscribers and monthly cost of service for each referral subscriber, multiplying each active referral subscriber by a weighted percentage based upon each referral subscriber's monthly cost of service to determine a set of weighted products, summing the weighted products to determine service credit percentage, and reducing the member's monthly service cost by the service credit percentage.

In still another form of the invention, the step of applying the service credit may further include the step of directly reducing the member's monthly service cost with the service provider. In an alternative embodiment, the step of applying the service credit may include providing a rebate to the member in the form of a direct deposit in the amount of the rebate to a bank account designated by the member.

In accordance with another aspect of the present invention, a system is provided for reducing turnover among subscribers to a service offered by a service provider. The system includes means for enrolling a user as a member of a customer network maintained by a subscription system operator, including means for requiring payment of an annual membership fee by the member and means for providing a premium to the member in return for the membership fee, means for establishing a subscriber account with the service provider on behalf of a member of the customer network, the account having a predetermined basic monthly service cost, means for implementing a data base of service provider subscribers that indicates an association between each member and the member's referral subscribers, the data base comprising a collection of records, with each record including at least one field that indicates subscribers referred by the member, and at least one associated field that indicates referral subscriber activity with the service provider, means for calculating a service credit for the member based upon activity of the referral subscribers, the means for calculating a service credit including means for accessing the data base of member records, means for enumerating the referral subscribers associated with each member, means for determining whether a member qualifies for a service credit based upon referral subscriber activity, and means for computing service credit amount based upon the referral subscriber activity, and means for applying the service credit to offset the member's predetermined basic monthly service cost. Thus, the member benefits by remaining a subscriber with the service provider in order to continue receiving reduced-cost service.

In accordance with yet another aspect of the present invention, a system is provided for reducing turnover among subscribers to a service offered by a service provider. The system comprises a memory device storing a program and a processor in communication with the memory, the processor operative with the program to enroll a user as a member of a customer network maintained by a subscription system operator, require payment of an annual membership fee by the member, provide a premium to the member in return for the membership fee, establish a subscriber account with the service provider on behalf of a member of the customer network, the account having a predetermined basic monthly service cost, implement a data base of service provider subscribers that indicates an association between each member and the member's referral subscribers, the data base comprising a collection of records, with each record including at least one field that indicates subscribers referred by the member, and at least one associated field that indicates referral subscriber activity with the service provider. The processor is further operative to calculate a service credit for the member based upon activity of the referral subscribers by accessing the data base of member records, enumerating the referral subscribers associated with each member, determining whether a member qualifies for a service credit based upon referral subscriber activity, and computing service credit amount based upon the referral subscriber activity. The service credit is applied to offset the member's predetermined basic monthly service cost, such that the member benefits by remaining a subscriber with the service provider in order to continue receiving reduced-cost service.

In accordance with still a further aspect of the present invention, a method is provided for reducing turnover among subscribers to a service offered by a service provider. The method comprises the steps of providing a web site system including a first web page that enables a user to purchase products and services, the web site system operated by a subscription system operator, the first web page also enabling a user to enroll as a member of a customer network maintained by the subscription system operator, electronically enrolling a user as a member of the customer network maintained by the subscription system operator, the process of enrolling a user as a member including the steps of requiring payment of an annual membership fee by the member, and providing a premium to the member in return for the membership fee, establishing a subscriber account with the service provider on behalf of a member of the customer network, the account having a predetermined basic monthly service cost, implementing a data base of service provider subscribers that indicates an association between each member and the member's referral subscribers, the data base comprising a collection of records, with each record including at least one field that indicates subscribers referred by the member, and at least one associated field that indicates referral subscriber activity with the service provider, calculating a service credit for the member based upon activity of the referral subscribers. The process of calculating a service credit includes the steps of accessing the data base of member records, enumerating the referral subscribers associated with each member, determining whether a member qualifies for a service credit based upon referral subscriber activity, enumerating total active referral subscribers, multiplying total active referral subscribers by a fixed percentage to determine service credit percentage, and reducing the member's monthly service cost by the service credit percentage. The method further includes the step of applying the service credit to offset the member's predetermined basic monthly service cost by providing a rebate to the member in the form of a direct deposit in the amount of the rebate to a bank account designated by the member, so that the member benefits by remaining a subscriber with the service provider in order to continue receiving reduced-cost service. The method may also include providing e-mail services to members, such that a member may transmit e-mail messages to any one of a limited group of designated e-mail recipients.

Further objects, features, and advantages of the present invention will become apparent from the following description and drawings.

### BRIEF DESCRIPTION OF THE DRAWINGS

FIG. 1 illustrates a system in accordance with the present invention in block diagram form;

FIG. 2 is a block diagram of another embodiment of a system in accordance with the present invention;

FIG. 3 is a stylized flow chart depicting operation of billing processes;

FIG. 4 is a block diagram of a plurality of components useful in implementing a web site and associated functions;

FIG. 5 is an exemplary computer display screen encountered during web site interaction; and

FIG. 6 is another exemplary computer display screen illustrating a portion of web site operation.

### DETAILED DESCRIPTION OF THE INVENTION

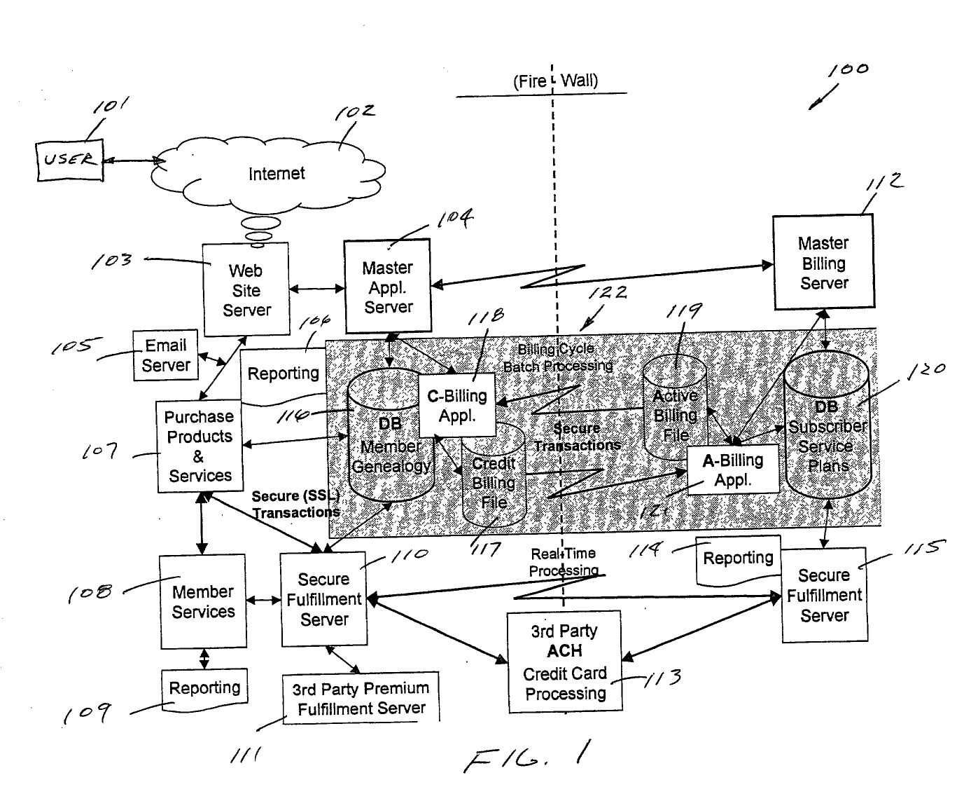

There is described herein a customer retention system that offers distinct advantages when compared to the prior art. The system is illustrated in block diagram form in FIG. 1, generally depicted by the numeral 100.

In accessing the system 100 in accordance with the present invention, a user 101 enters the uniform resource locator (URL) for the subscription system operator's web site over the Internet 102, using a web browser as is well-known in the art. The web site is hosted by web site server 103. The web site server 103 communicates with a master application server 104, where the application computer program that actually operates the web site resides. The user 101 is directed to an enrollment screen, and the enrollment information that the user 101 provides is confirmed with the user by e-mail, using the associated e-mail server 105. The user 101 is then presented with the opportunity to purchase products and services through a purchasing application 107. In the preferred form of the invention, the user 101 enrolls as a customer and agrees to pay a subscription fee in return for a premium package of products, rebates, and discounts. Of course, subscribing is not required in order for the user to derive benefit from the system. The user may simply elect to purchase products through the web site.

Should the user 101 elect to enroll as a member, the purchasing application 107 creates a record for the user 101 in the member genealogy data base 116 under control of the application program on the master application server 104. In addition, the member services application 108 allows the user to select among available premiums to which the user 101 is entitled by virtue of his subscription. The member services application 108 communicates with a secure fulfillment server 110, using a secure protocol such as a secure sockets layer (SSL) to ensure that the member's information is safeguarded from inadvertent disclosure.

In order to deliver the premium to which the member is entitled, a third-party fulfillment sever 111, as part of a readily available service, undertakes to deliver the premium (in the form of products, rebates, and discounts, for example) to the subscriber. A reporting application 109 is capable of generating reports in various formats that identify the user, his associated premiums, and his level of participation.

As noted, in the preferred form of the system, the user has the opportunity, once he becomes a subscriber, to enter into an agreement with a wireless service provider to obtain cellular telephone service. This is the primary purpose for creation of the genealogy data base 116, as will become apparent during the forthcoming discussion. Of course, the system described works equally well for any type of service enterprise, so it is not intended that the invention be limited to service businesses in the telecommunications industry. As described above, the system of the invention works equally well for general merchandise sales and distribution, fast food service, gasoline and fuels, Web/ISP, and travel and leisure services, just for example.

One of the objectives of the present system is to enable customer acquisition and retention for selected service businesses. In the preferred embodiment, the subscriber is encouraged to refer other subscribers, selected from among friends and family members, for example, to participate in the same wireless communication service opportunity. In one form of the invention, the original subscriber is entitled to a ten-percent service credit (or fixed dollar amount of rebate) against his own monthly service cost for each additional subscriber he refers. Preferably, the service credit applies only to his basic monthly cost of service, so the original subscriber does not have the opportunity to defray the cost of premium services (long distance, roaming, cellular-to-cellular, handset-based internet browser services, just to name a few). Of course, this sort of more complex service cost credits could be devised as a part of a more advanced system.

Since there are normally varied levels of service plans available (at varied costs) from a telecommunications service provider, it may also be possible to take into account the cost of a recruited subscriber's service plan in computing the amount of the monthly service credit that should be attributed to a given subscriber. For example, if an original subscriber manages to refer downline subscribers who select expensive rate plans, it may be possible to compute his total service credit based upon these higher monthly costs, so it may require only eight recruited subscribers to offset the level zero subscriber's monthly service cost. We may term this original subscriber the zero-level subscriber, and the subscribers that he recruits may be his one-level subscribers, or his downline.

It may also be possible, in an enhanced system in accordance with the present invention, to adjust the number of downline subscribers necessary to offset the monthly service cost for a level zero subscriber who elects a premium service plan. The impact of downline subscribers on the level zero subscriber's monthly service cost could be weighted, for example, in accordance with the monthly cost of each downline subscriber's plan.

In any event, sophisticated billing processing, generally depicted by the numeral 122, accompanies the system in accordance with the present invention. Since all subscribers generally would have different ending dates for their billing cycles, the impact of the downline in defraying the cost of the level zero subscriber's service is computed one month in arrears for the sake of simplicity. A master billing computer application program resident on the master billing server 112 computes subscriber bills, taking into account the impact of the downline by accessing the genealogy data base 116. As noted above, the genealogy data base 116 tracks the relationship between a particular level zero subscriber and that subscriber's downline, or level one subscribers.

The active billing application 121 computes customer bills by charging each customer for minutes used under the terms of the customer's service plan, as recorded in the subscriber service plans data base 120. The computed customer bills, as recorded in the customer active billing file 119, are then submitted in batch for adjustment by the credit billing application 118. By extracting downline customer usage based upon cross-referencing through the genealogy data base 118, the credit billing application can adjust each level zero customer's bill based upon the participation of his downline.

Of course, a secure fulfillment server 115, as known in the art, takes care of order fulfillment based upon customer service plans. This may entail the provision of the appropriate cellular phone model for a particular service plan, for example. The fulfillment server 115 has an associated reporting application 114 for generating reports that record order fulfillments as they occur for particular customers. And, just as in many e-commerce applications, payment of accounts is handled seamlessly through a third party automated clearing house (ACH) and credit card processing application 113.

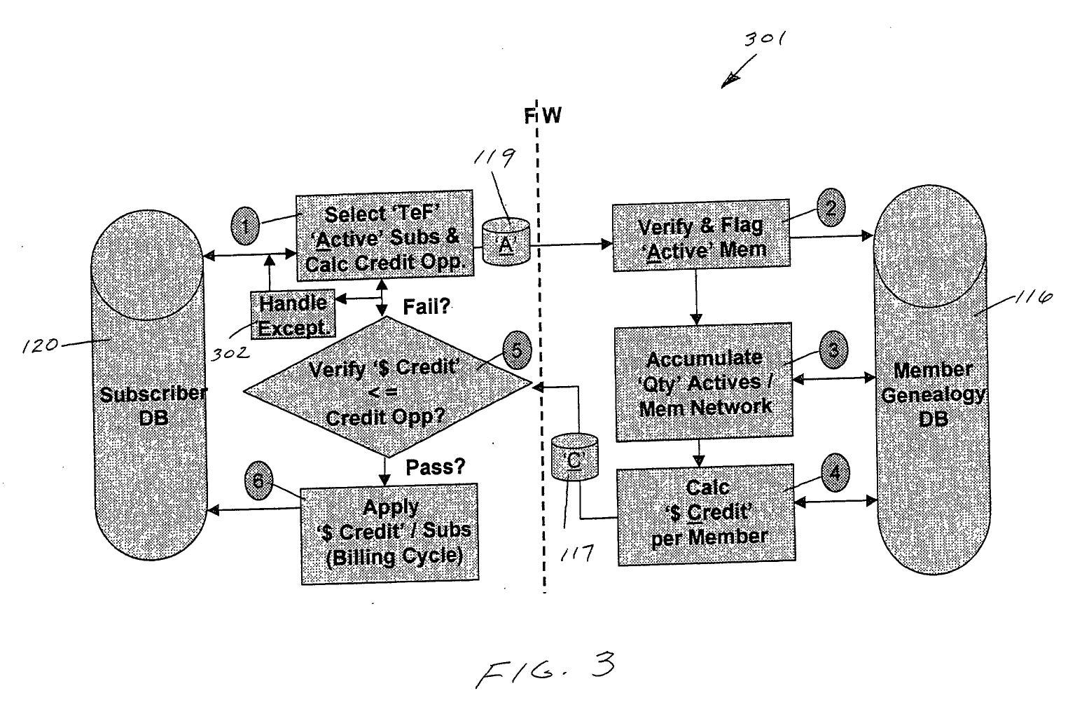

Operation of the billing segment is illustrated in the stylized flow chart of FIG. 3 and generally depicted by the numeral 301. In block 1, the service provider accesses its telecommunications service subscriber data base 120, and checks several fields in each subscriber record. First, the Agent record is checked for a match with the subscription system operator of the present invention, and, if a match occurs, the Active field is checked to determine whether the subscriber's telecommunications service account is active. If so, that subscriber record is made a part of the active billing file 119. As a minimum, each record in the active billing file 119 should include the subscriber's account number, name and address information, and basic service plan cost. If either of the preceding tests fails, the subscriber data base search simply proceeds to the next record.

In block 2, since the subscription system operator has shared access to the active billing file 119 constructed by the telecommunications service provider, the subscription system operator checks each entry in the active billing file 119 and updates the genealogy data base 116 active member field, so that the genealogy data base 116 accurately reflects the subscription system members who are active subscribers on the telecommunications service provider's system. In block 3, the subscription system operator enumerates the total quantity of referral subscribers for each member.

Then in block 4, based upon this information, the subscription system operator builds a shared credit billing file 117 that includes each member that has obtained a credit based upon referral subscribers during the past month. The amount of the credit due to each member as a result of the activity of referred subscribers (the member's downline) is computed and entered into the credit billing file.

Of course, there are a number of ways of computing the credit due for each member. In accordance with one embodiment, a simple percentage credit (8.33 percent, for example) is applied to each member's account for each active subscriber that the member has referred, up to a limit of twelve referral subscribers. At a credit percentage of 8.33 percent per referral, twelve referral subscribers will completely offset the member's basic cost of service. Naturally, a different fixed percentage could be applied, resulting in a different number of referral subscribers required to offset basic service cost.

Other methods of computing the credit may include a weighted computation in which the cost of the member's basic service is taken into account. Since there are generally a number of service plans offered by a telecommunications service provider, all with different basic costs, the subscription system operator may elect to require a larger number of referral subscribers to offset the cost of service for members with more expensive service plans.

The cost of the service plans for the referral subscribers may also be taken into account. By way of example, one may assume that the telecommunications service provider offers three different service plans: an economy plan for $30 per month, a more inclusive plan costing $40 per month, and a deluxe plan at a cost of $50 per month. Maintaining a fixed credit percentage of 8.33% for each referral (for example), the subscription system operator may elect to reduce the number of referrals necessary to offset the member's basic cost of service, provided that the member refers subscribers with more expensive service plans. Each referral subscriber having a $50 per month service plan may have a credit percentage of 12.5%, for example, and only eight of these $50 referral subscribers would be required to offset the member's cost of service. Similarly, each referral subscriber having a $40 per month plan may be assigned a credit percentage of 10%, so that only 10 of these $40 subscribers would be required to offset the Member's monthly service cost.

One could also elect to introduce a more complex computation, in which the cost of the member's service plan becomes an element in determining the number of referral subscribers required to offset the member's monthly cost. And, indeed, one could devise an incrementally more complex algorithm in which both the member's monthly service plan cost, and the service plan costs of each referral subscriber, become elements in the ultimate determination of the number and service level of the referral subscribers required to offset the member's monthly cost of service. For example, a formula could be utilized that applies a credit weight of 12.5% to each $50 service plan referral, 10% to each $40 referral, and 8.33% to each $30 referral, until the cost of the member's service plan has been completely offset. At that point, the member would not be required to refer any additional telecommunications system subscribers in order to offset his own monthly service cost. Of course, a member may refer as many additional customers as he likes, but the credit he receives may not exceed the monthly cost of his own service plan.

No matter how the credit computation is carried out, the telecommunications service provider updates the entries in the active billing file 119 to reflect the credits against cost of service that are computed by the subscription system operator. The telecommunications service provider may wish to introduce some form of exception processing 302 in order to handle subscribers whose accumulated downline seems to reduce their bill by more than the basic service cost. For these subscribers, their cost of service cannot be reduced by more than the cost of their monthly service plan, and their records in the active billing file 119 must be adjusted accordingly. Finally, in block 6, the adjusted bills are sent to customers. Arrangements may be made for ACH or credit card processing of bill payment, for customer convenience.

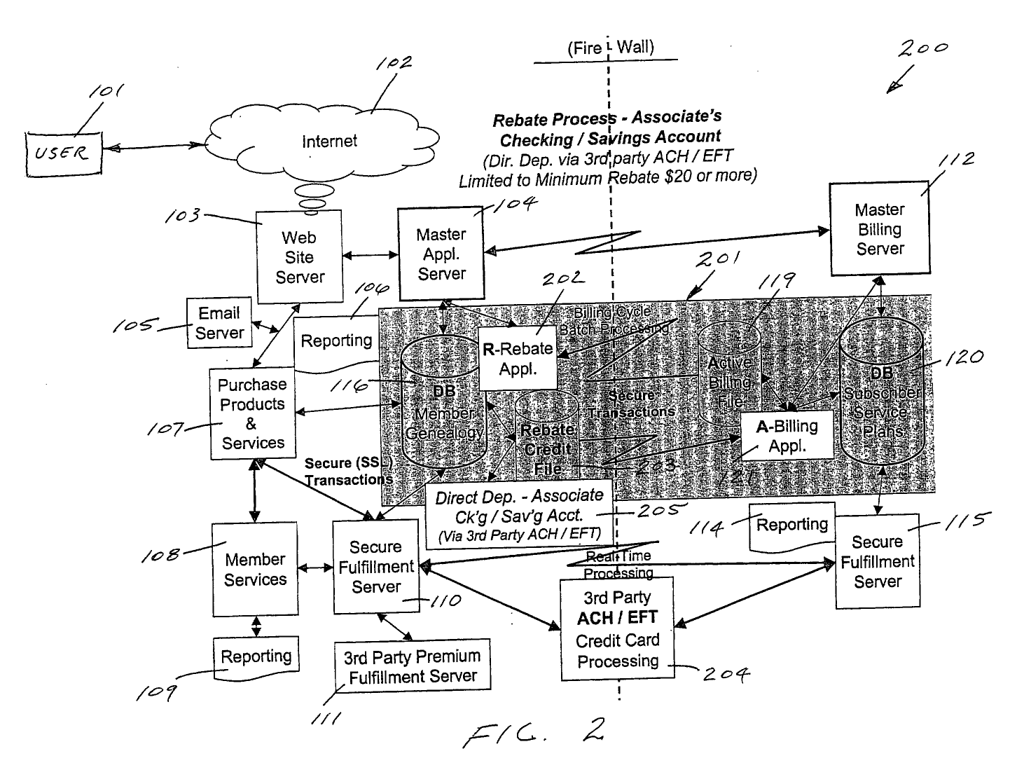

FIG. 2 illustrates yet a further modification to the billing cycle batch processing 201 in accordance with the present invention. FIG. 2 is a block diagram of the system in accordance with the present invention, and retains the same reference symbols used in FIG. 1 for system components that are essentially the same as those described above.

In the billing processing 201 of FIG. 2, any credit due to a subscriber because of his referral subscribers may be returned to the subscriber as a credit, rather than being applied directly to his bill. Instead of a credit billing application (118 in FIG. 1) that creates a credit billing file (117 in FIG. 1) based upon the activity of downline subscribes, a rebate application 202 constructs a rebate billing file 203 whose file records identify those subscribers who are due a rebate generated in accordance with their downline subscribers' activity. The credit (or rebate) so identified may be delivered to the subscriber by mail in the form of a refund check, for example, or the rebate amount may be placed in a designated bank account by direct transfer 205 using a third-party ACH/EFT (electronic funds transfer)/credit card processing center 204.

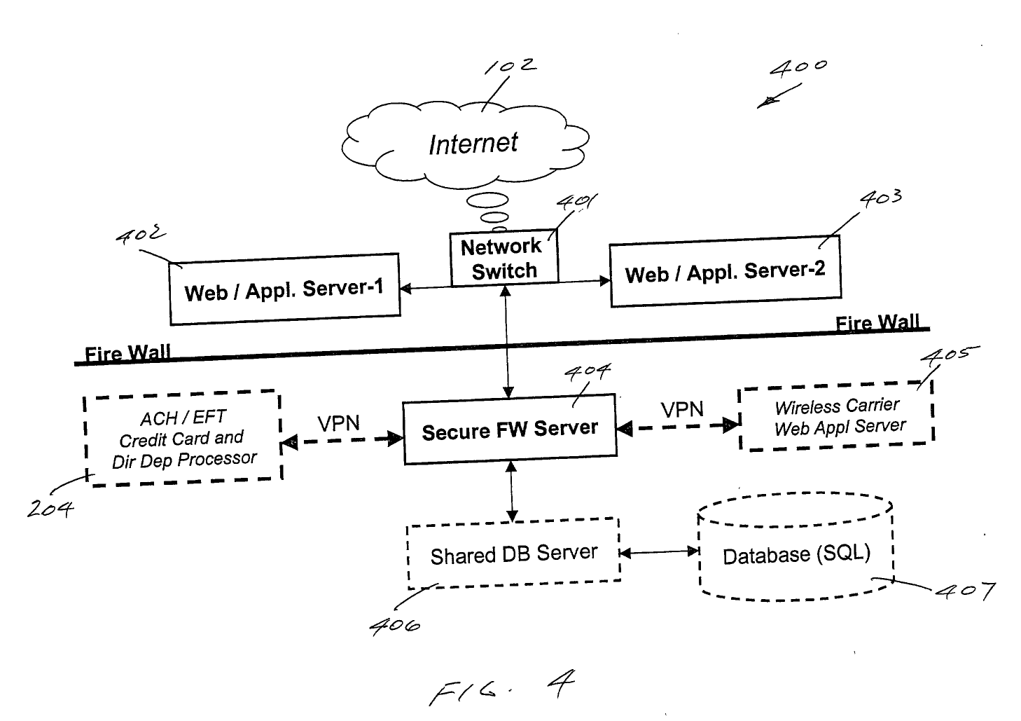

FIG. 4 illustrates, in block diagram form, a plurality of components adaptable to implement a web site and associated functions (generally depicted by the numeral 400) in accordance with the present invention. In the illustrated implementation, a user attempting to reach the subscription system operator's web site over the internet 102 is directed through a network switch 401 to either of two web/application servers 402, 403. Shared data bases and associated servers, such as the wireless carrier's web application server 405, are isolated from the network switch 401 by a secure firewall server 404.

Both the wireless carrier's web server 405 and third party services, such as the ACH/EFT/credit card and direct deposit processor 204, are accessible to the fire wall server 404 via virtual private network (VPN) connections. The secure file wall server 404 also enables access to a shared data base server 406 designed to access the shared data bases 407 using SQL (an industry-standard language for creating, updating and querying relational database management systems). The servers 402-404 are preferably based upon 1 GHz (gigahertz) Pentium-III processors with redundant 18 GB (gigabyte) hard disk systems for the sake of reliability. Each server preferably includes 512 MB (megabytes) of RAM (random access memory) and two network interface cards. It is desirable that the servers use the Linux operating system, but other computer operating systems may also be adaptable to this application. Of course, in order to support secure interconnections, the servers should be equipped with appropriate SSL certificates, as is well-known in the art. The Dell 2550, manufactured by Dell Computer, is a satisfactory network server. Of course, similar computer systems having comparable hardware and software may also be usable in this application.

In operation, as described above, the system of the present invention allows users to access the subscription system operator's web site over the internet. The first web page displayed by the operator's web site is not illustrated in the drawings, but generally includes advertising content as well as links to other portions of the site that support enrollment for the services provided by the subscription system operator. In the preferred form of the system, this enrollment, as explained previously, may allow the system user to make purchases of products and services offered by the subscription system operator. At another level, the web site also enables the user to enroll as a participant in selected services. In the preferred form of the system, telecommunications are among the selected services.

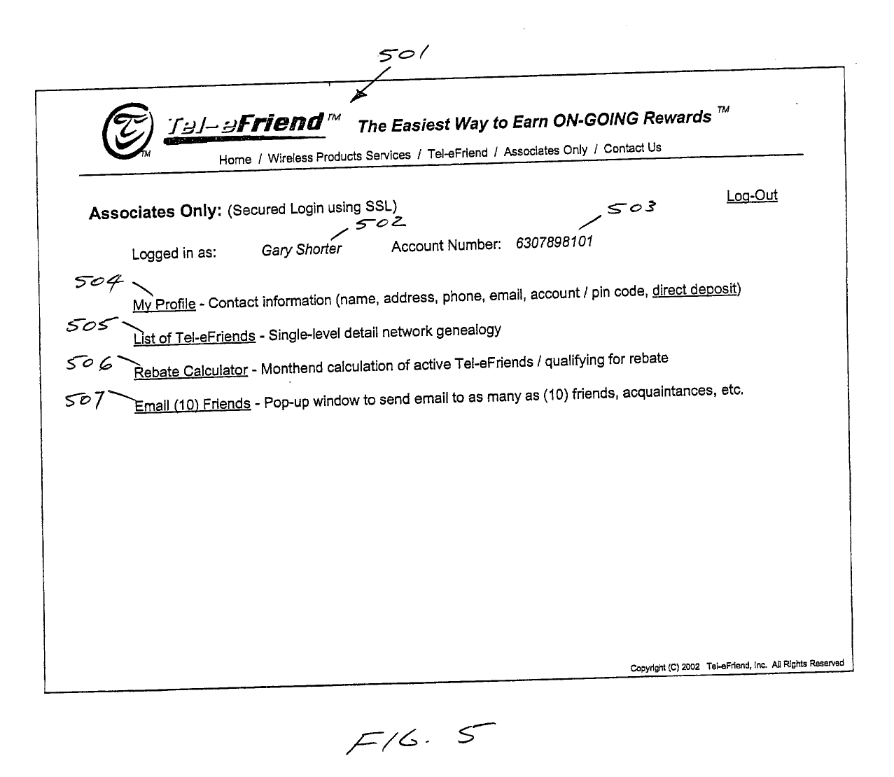

A user who has elected to become a participant in the telecommunications service (or other services offered by the subscription system operator) may access a log-on screen for members that is accessible via a hyperlink on the initial page displayed by the web site. After entering his or her login name and password, the user is directed to the exemplary member screen of FIG. 5. It should be noted that a logo 501 identifying the subscription system operator (Tel-eFriend™) is displayed near the top of the screen, along with links to other pages accessible on the site.

On the screen of FIG. 5, the user's login name 502 and account number 503 are displayed, along with links 504-507 to other useful member areas of the site. These links include a profile link 504 that allows the user to review and correct personal details such as name, address, phone number and bank account information. The member screen also allows access to a list of referred (downline) subscribers through the list link 505. A rebate calculator link 506 allows the user to confirm the extent to which his downline subscribers will defray his monthly cost of telecommunications service, while an e-mail link 507 directs the user to pop-up windows for composing e-mails to a predetermined list of recipients.

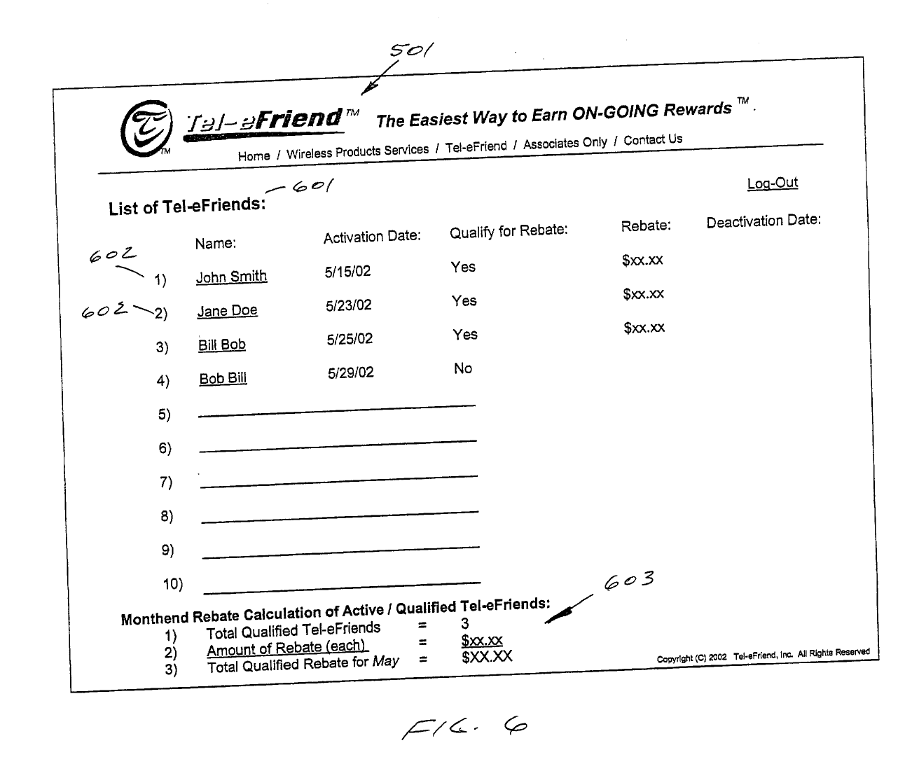

FIG. 6 illustrates a typical list page accessible through the list link 505 of FIG. 5. The list page of FIG. 6 also includes a logo display 501 for the subscription system operator and a collection of relevant links for navigation around the site. Beneath the page title 601, a list of the user's referral subscribers 602 is displayed, along with pertinent data such as activation date, rebate qualification, and amount of rebate (if known). Of course, the screen of FIG. 5 may be adapted to display more than just ten downline subscribers (Tel-eFriends) if the selected rebate computation method so warrants. At the bottom of the screen of FIG. 6, a convenient rebate calculation display 603 is provided to give the user immediate feedback regarding the amount of his projected rebate based upon his referral subscribers.

There has been described herein a customer retention system that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A method for reducing turnover among subscribers to a service offered by a service provider, the method comprising the steps of:
(a) enrolling a user as a member of a customer network maintained by a subscription system operator;
(b) establishing a subscriber account with the service provider on behalf of a member of the customer network, said account having a predetermined basic monthly service cost;
(c) implementing a data base of service provider subscribers that indicates an association between each member and said member's referral subscribers;
(d) calculating a service credit for said member based upon activity of said referral subscribers; and
(e) applying said service credit to offset said member's predetermined basic monthly service cost;
such that said member benefits by remaining a subscriber with said service provider in order to continue receiving reduced-cost service.

2. The method in accordance with claim 1, wherein the step (a) of enrolling a user as a member of a customer network further comprises the step of requiring payment of an annual membership fee by the member, and providing a premium to the member in return for said membership fee.

3. The method in accordance with claim 2, wherein said premium is provided, at least in part, in the form of one or more products delivered to the member.

4. The method in accordance with claim 2, wherein said premium is provided in the form of, at least in part, discounts redeemable by the member for predetermined products.

5. The method in accordance with claim 2, wherein said premium is provided in the form of, at least in part, discounts redeemable by the member for predetermined services.

6. The method in accordance with claim 1, wherein the step (c) of implementing a data base of service provider subscribers further comprises the step of implementing a data base comprising member records, with each record including at least one field that indicates subscribers referred by said member, and at least one associated field that indicates referral subscriber activity with the service provider.

7. The method in accordance with claim 1, wherein the step (d) of calculating a service credit further includes the steps of:
(d1) accessing the data base of member records;
(d2) enumerating the referral subscribers associated with each member;
(d3) determining whether a member qualifies for a service credit based upon referral subscriber activity; and
(d4) computing service credit amount based upon said referral subscriber activity.

8. The method in accordance with claim 7, wherein the step (d4) of computing service credit amount further comprises the steps of:
(d5) enumerating total active referral subscribers;
(d6) multiplying total active referral subscribers by a fixed percentage to determine service credit percentage; and
(d7) reducing the member's monthly service cost by the service credit percentage.

9. The method in accordance with claim 8, wherein the fixed percentage comprises 8.33%.

10. The method in accordance with claim 7, wherein the step (d4) of computing service credit amount further comprises the steps of:
(d8) enumerating total active referral subscribers and monthly cost of service for each referral subscriber;
(d9) multiplying each active referral subscriber by a weighted percentage based upon each referral subscriber's monthly cost of service to determine a set of weighted products;
(d10) summing said weighted products to determine service credit percentage; and
(d11) reducing the member's monthly service cost by the service credit percentage.

11. The method in accordance with claim 1, wherein the step (e) of applying said service credit further comprises the step of directly reducing said member's monthly service cost with said service provider.

12. The method in accordance with claim 1, wherein the step (e) of applying said service credit further comprises the step of providing a rebate to said member in the form of a direct deposit in the amount of the rebate to a bank account designated by said member.

13. A method for reducing turnover among subscribers to a service offered by a service provider, the method comprising the steps of:
(a) enrolling a user as a member of a customer network maintained by a subscription system operator, the process of enrolling a user as a member including the steps of requiring payment of an annual membership fee by the member, and providing a premium to the member in return for said membership fee;
(b) establishing a subscriber account with the service provider on behalf of a member of the customer network, said account having a predetermined basic monthly service cost;
(c) implementing a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
(d) calculating a service credit for said member based upon activity of said referral subscribers, the process of calculating a service credit including the steps of:
(i) accessing the data base of member records;
(ii) enumerating the referral subscribers associated with each member;
(iii) determining whether a member qualifies for a service credit based upon referral subscriber activity; and
(iv) computing service credit amount based upon said referral subscriber activity; and
(e) applying said service credit to offset said member's predetermined basic monthly service cost;
such that said member benefits by remaining a subscriber with said service provider in order to continue receiving reduced-cost service.

14. The method in accordance with claim 13, wherein said premium is provided, at least in part, in the form of one or more products delivered to the member.

15. The method in accordance with claim 13, wherein said premium is provided in the form of, at least in part, discounts redeemable by the member for predetermined products.

16. The method in accordance with claim 13, wherein said premium is provided in the form of, at least in part, discounts redeemable by the member for predetermined services.

17. The method in accordance with claim 13, wherein the step (d)(iv) of computing service credit amount further comprises the steps of:
(a) enumerating total active referral subscribers;
(b) multiplying total active referral subscribers by a fixed percentage to determine service credit percentage; and
(c) reducing the member's monthly service cost by the service credit percentage.

18. The method in accordance with claim 17, wherein the fixed percentage comprises 8.33%.

19. The method in accordance with claim 13, wherein the step (d)(iv) of computing service credit amount further comprises the steps of:
(a) enumerating total active referral subscribers and monthly cost of service for each referral subscriber;
(b) multiplying each active referral subscriber by a weighted percentage based upon each referral subscriber's monthly cost of service to determine a set of weighted products;
(c) summing said weighted products to determine service credit percentage; and
(d) reducing the member's monthly service cost by the service credit percentage.

20. The method in accordance with claim 13, wherein the step (e) of applying said service credit further comprises the step of directly reducing said member's monthly service cost with said service provider.

21. The method in accordance with claim 13, wherein the step (e) of applying said service credit further comprises the step of providing a rebate to said member in the form of a direct deposit in the amount of the rebate to a bank account designated by said member.

22. A method for reducing turnover among subscribers to a service offered by a service provider, the method comprising the steps of:
(a) enrolling a user as a member of a customer network maintained by a subscription system operator, the process of enrolling a user as a member including the steps of requiring payment of an annual membership fee by the member, and providing a premium to the member in return for said membership fee;
(b) establishing a subscriber account with the service provider on behalf of a member of the customer network, said account having a predetermined basic monthly service cost;
(c) implementing a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
(d) calculating a service credit for said member based upon activity of said referral subscribers, the process of calculating a service credit including the steps of:
(i) accessing the data base of member records;
(ii) enumerating the referral subscribers associated with each member;
(iii) determining whether a member qualifies for a service credit based upon referral subscriber activity;
(iv) enumerating total active referral subscribers;
(v) multiplying total active referral subscribers by a fixed percentage to determine service credit percentage; and
(vi) reducing the member's monthly service cost by the service credit percentage; and
(e) applying said service credit to offset said member's predetermined basic monthly service cost by providing a rebate to said member in the form of a direct deposit in the amount of the rebate to a bank account designated by said member;
such that said member benefits by remaining a subscriber with said service provider in order to continue receiving reduced-cost service.

23. The method in accordance with claim 22, wherein said premium is provided, at least in part, in the form of one or more products delivered to the member.

24. The method in accordance with claim 22, wherein said premium is provided in the form of, at least in part, discounts redeemable by the member for predetermined products.

25. The method in accordance with claim 22, wherein said premium is provided in the form of, at least in part, discounts redeemable by the member for predetermined services.

26. A system for reducing turnover among subscribers to a service offered by a service provider comprising:
means for enrolling a user as a member of a customer network maintained by a subscription system operator, including means for requiring payment of an annual membership fee by the member and means for providing a premium to the member in return for said membership fee;
means for establishing a subscriber account with the service provider on behalf of a member of the customer network, said account having a predetermined basic monthly service cost;
means for implementing a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
means for calculating a service credit for said member based upon activity of said referral subscribers, the means for calculating a service credit including:
means for accessing the data base of member records;
means for enumerating the referral subscribers associated with each member;
means for determining whether a member qualifies for a service credit based upon referral subscriber activity; and
means for computing service credit amount based upon said referral subscriber activity; and
means for applying said service credit to offset said member's predetermined basic monthly service cost;
such that said member benefits by remaining a subscriber with said service provider in order to continue receiving reduced-cost service.

27. The system in accordance with claim 26, wherein the means for computing service credit amount further comprises:
means for enumerating total active referral subscribers;
means for multiplying total active referral subscribers by a fixed percentage to determine service credit percentage; and
means for reducing the member's monthly service cost by the service credit percentage.

28. The system in accordance with claim 27, wherein the fixed percentage comprises 8.33%.

29. The system in accordance with claim 26, wherein the means for computing service credit amount further comprises:
means for enumerating total active referral subscribers and monthly cost of service for each referral subscriber;
means for multiplying each active referral subscriber by a weighted percentage based upon each referral subscriber's monthly cost of service to determine a set of weighted products;
means for summing said weighted products to determine service credit percentage; and
means for reducing the member's monthly service cost by the service credit percentage.

30. The system in accordance with claim 26, wherein the means for applying said service credit further comprises means for directly reducing said member's monthly service cost with said service provider.

31. The system in accordance with claim 26, wherein the means for applying said service credit further comprises means for providing a rebate to said member in the form of a direct deposit in the amount of the rebate to a bank account designated by said member.

32. A system for reducing turnover among subscribers to a service offered by a service provider comprising:
means for enrolling a user as a member of a customer network maintained by a subscription system operator, including means for requiring payment of an annual membership fee by the member and means for providing a premium to the member in return for said membership fee;
means for establishing a subscriber account with the service provider on behalf of a member of the customer network, said account having a predetermined basic monthly service cost;
means for implementing a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
means for calculating a service credit for said member based upon activity of said referral subscribers, the means for calculating a service credit including:
means for accessing the data base of member records;
means for enumerating the referral subscribers associated with each member;
means for determining whether a member qualifies for a service credit based upon referral subscriber activity;
means for enumerating total active referral subscribers;
means for multiplying total active referral subscribers by a fixed percentage to determine service credit percentage; and
means for reducing the member's monthly service cost by the service credit percentage; and
means for applying said service credit to offset said member's predetermined basic monthly service cost by providing a rebate to said member in the form of a direct deposit in the amount of the rebate to a bank account designated by said member;
such that said member benefits by remaining a subscriber with said service provider in order to continue receiving reduced-cost service.

33. A system for reducing turnover among subscribers to a service offered by a service provider comprising:
a memory device storing a program;
a processor in communication with the memory, the processor operative with said program to:
enroll a user as a member of a customer network maintained by a subscription system operator;
require payment of an annual membership fee by the member;
provide a premium to the member in return for said membership fee;
establish a subscriber account with the service provider on behalf of a member of the customer network, said account having a predetermined basic monthly service cost;
implement a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
calculate a service credit for said member based upon activity of said referral subscribers by:
accessing the data base of member records;
enumerating the referral subscribers associated with each member;
determining whether a member qualifies for a service credit based upon referral subscriber activity; and
computing service credit amount based upon said referral subscriber activity; and
apply said service credit to offset said member's predetermined basic monthly service cost;
such that said member benefits by remaining a subscriber with said service provider in order to continue receiving reduced-cost service.

34. The system in accordance with claim 33, wherein the processor is operative to compute service credit amount based upon referral subscriber activity by:
enumerating total active referral subscribers;
multiplying total active referral subscribers by a fixed percentage to determine service credit percentage; and
reducing the member's monthly service cost by the service credit percentage.

35. The system in accordance with claim 34, wherein the fixed percentage comprises 8.33%.

36. The system in accordance with claim 33, wherein the processor is operative to compute service credit amount based upon referral subscriber activity by:
enumerating total active referral subscribers and monthly cost of service for each referral subscriber;
multiplying each active referral subscriber by a weighted percentage based upon each referral subscriber's monthly cost of service to determine a set of weighted products;
summing said weighted products to determine service credit percentage; and
reducing the member's monthly service cost by the service credit percentage.

37. The system in accordance with claim 33, wherein the processor is operative to apply said service credit by directly reducing said member's monthly service cost with said service provider.

38. The system in accordance with claim 33, wherein the processor is operative to apply said service credit by providing a rebate to said member in the form of a direct deposit in the amount of the rebate to a bank account designated by said member.

39. A method for reducing turnover among subscribers to a service offered by a service provider, the method comprising the steps of:
(a) providing a web site system including a first web page that enables a user to purchase products and services, said web site system operated by a subscription system operator, said first web page also enabling a user to enroll as a member of a customer network maintained by the subscription system operator;
(b) electronically enrolling a user as a member of the customer network maintained by the subscription system operator, the process of enrolling a user as a member including the steps of requiring payment of an annual membership fee by the member, and providing a premium to the member in return for said membership fee;
(c) establishing a subscriber account with the service provider on behalf of a member of the customer network, said account having a predetermined basic monthly service cost;
(d) implementing a data base of service provider subscribers that indicates an association between each member and said member's referral subscribers, said data base comprising a collection of records, with each record including at least one field that indicates subscribers referred by said member, and at least one associated field that indicates referral subscriber activity with the service provider;
(e) calculating a service credit for said member based upon activity of said referral subscribers, the process of calculating a service credit including the steps of:
(i) accessing the data base of member records;
(ii) enumerating the referral subscribers associated with each member;
(iii) determining whether a member qualifies for a service credit based upon referral subscriber activity;
(iv) enumerating total active referral subscribers;
(v) multiplying total active referral subscribers by a fixed percentage to determine service credit percentage; and
(vi) reducing the member's monthly service cost by the service credit percentage; and
(f) applying said service credit to offset said member's predetermined basic monthly service cost by providing a rebate to said member in the form of a direct deposit in the amount of the rebate to a bank account designated by said member;
such that said member benefits by remaining a subscriber with said service provider in order to continue receiving reduced-cost service.

40. The method in accordance with claim 39, further comprising the step of providing e-mail services to members, such that a member may transmit e-mail messages to any one of a limited group of designated e-mail recipients.
